(19) United States
(12) Patent Application Publication
(10) Pub. No.: US 2026/0289317 A1
(43) Pub. Date: Sep. 24, 2026

(54) IDENTIFYING PREVIOUSLY UNKNOWN SENSITIVE DATA CATEGORIES WITH CATEGORY-AGNOSTIC MACHINE LEARNING

(71) Applicant: Palo Alto Networks, Inc., Santa Clara, CA (US)

(72) Inventors: Tung-Ling Li, Fremont, CA (US); Sheena Agarwal, San Jose, CA (US); Gacoka Mbui, San Jose, CA (US); William Redington Hewlett, II, Mountain View, CA (US); Priyansh Jaiswal, San Jose, CA (US); Anubhav Gupta, Danville, CA (US); Jahnavi Gangula Reddy, San Jose, CA (US)

(21) Appl. No.: 19/087,810

(22) Filed: Mar. 24, 2025

(51) Int. Cl. G06N 3/0895

(52) U.S. Cl. CPC G06N 3/0895

(57) ABSTRACT

A category-agnostic data loss prevention system (“DLP system”) leverages multiple metrics to identify clusters of documents corresponding to “shadow data” categories, i.e., categories of sensitive data that are not previously known to an organization. As unknown clusters are identified, the DLP system computes these metrics based on descriptions of the clusters, summaries of documents within each cluster, and metadata of each cluster. The DLP system then ranks the unknown clusters by priority for being evaluated as corresponding to shadow data, and domain-level experts begin inspecting the highest priority unknown clusters to attempt to identify additional sensitive data categories for the unknown clusters.

### BACKGROUND

The disclosure generally relates to data processing and computing arrangements based on computational models (e.g., CPC subclass G06N and CPC subclass G06F 16).

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model, and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large language models (LLMs) are based on the Transformer architecture. An LLM is “large” because the training parameters are typically in the billions. LLMs can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model or changing the weights of the language model.

Data loss prevention (DLP) refers to a system's ability to identify, monitor, and protect data in use, data in motion, and data at rest. Data loss is the loss of control of confidential or sensitive data (“data leakage”) and/or the compromise of integrity or availability of data. The different states of data (i.e., data at rest, data in-motion or in-transit, and data at the endpoint) have different vectors of data loss. The ability to monitor and protect data in motion can also be referred to as data leakage prevention. One vector of data loss is directly from users, for instance by accidentally communicating sensitive data over public or vulnerable channels of communication such as chat messages communicated via Software-as-a-Service applications.

### BRIEF DESCRIPTION OF THE DRAWINGS

Embodiments of the disclosure may be better understood by referencing the accompanying drawings.

FIG. 1 is a diagram of a category-agnostic DLP system computing category-agnostic metrics of clusters with LLMs.

FIG. 2 is an illustrative diagram of determining a sensitivity label and/or metric for a document and/or cluster using next token probabilities for an LLM.

FIG. 3 is a diagram of the category-agnostic DLP system computing a cluster similarity metric(s) of an unknown cluster with clusters having known sensitive data categories and determining whether the unknown cluster corresponds to shadow data based on a combination of metrics.

FIG. 4 is a flowchart of example operations for prioritizing document clusters for shadow data categorization based on category-agnostic metrics.

FIG. 5 is a flowchart of example operations for determining a sensitivity metric for a cluster description of an unknown cluster.

FIG. 6 is a flowchart of example operations for determining a sensitivity metric for cluster documents of an unknown cluster.

FIG. 7 is a flowchart of example operations for determining a similarity metric(s) between an unknown cluster and known clusters.

FIG. 8 depicts an example computer system with a category-agnostic DLP system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

When an organization has predefined categories of sensitive data for DLP and corresponding catalogued sensitive documents, data profiles, etc. many DLP systems of the organization are trained/configured to detect sensitive data specific to those predefined categories. For instance, the DLP systems can be configured with regular expressions engineered to detect sensitive words/phrases for specific categories, machine learning models can be trained on known documents for specific categories, etc. These DLP systems have inherent deficiencies due to this configuration/training—sensitive documents belonging to categories not yet defined by the organization can elude detection. Data in documents that have categories that are not yet defined and/or detected by the DLP systems of the organization, but that is nonetheless contained in documents stored within the organizational infrastructure, is herein defined as “shadow data.” Shadow data is a blanket term that refers to any data satisfying these criteria, regardless of the (unknown) ground truth category.

A category-agnostic DLP system (“DLP system”) disclosed herein leverages both category-agnostic and category-dependent metrics for clusters of documents without known categories (i.e., clusters that evaded detection by a DLP system for known categories of sensitive data) to detect clusters corresponding to shadow data. Each cluster is assumed to have a description of the cluster as a whole as well as a summary of each document in the cluster (e.g., descriptions/summaries generated by prompting LLMs to summarize the documents). The DLP system computes three category-agnostic metrics (i.e., metrics computed independently of a set of sensitive data categories specific to and known for an organization)—cluster sensitivity metrics and percentages of sensitive documents determined using LLMs on the cluster description and document summaries, respectively, and the number of documents in a cluster because clusters with more documents are more likely to correspond to sensitive data. The DLP system also computes a category-dependent metric by comparing an embedding of the cluster description with embeddings of data profiles for known categories and computing similarity of the cluster description embedding with the data profile embeddings. The DLP system uses a combination of these metrics to prioritize unknown clusters for evaluation by identifying those most likely to correspond to shadow data. The use of the DLP system facilitates manual review by domain-level experts when the number of unknown clusters is high by increasing priority for clusters most likely to have sensitive documents, resulting in a higher percentage of identifications for new sensitive data categories that were previously shadow data categories.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The term “unknown cluster” as used herein refers to a cluster of documents that cannot be assigned to a known cluster corresponding to a known category of sensitive data for an organization (e.g., the unknown cluster is too far from known clusters in embedding space).

The term “sensitivity” as used herein refers to the state and/or quality of comprising and/or corresponding to sensitive data in the context of DLP.

### Example Illustrations

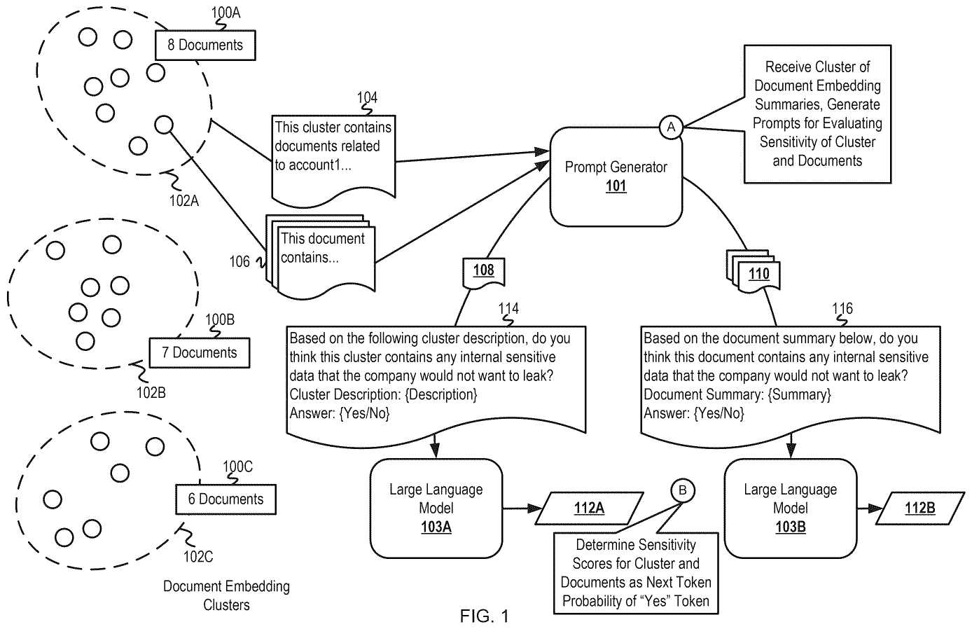

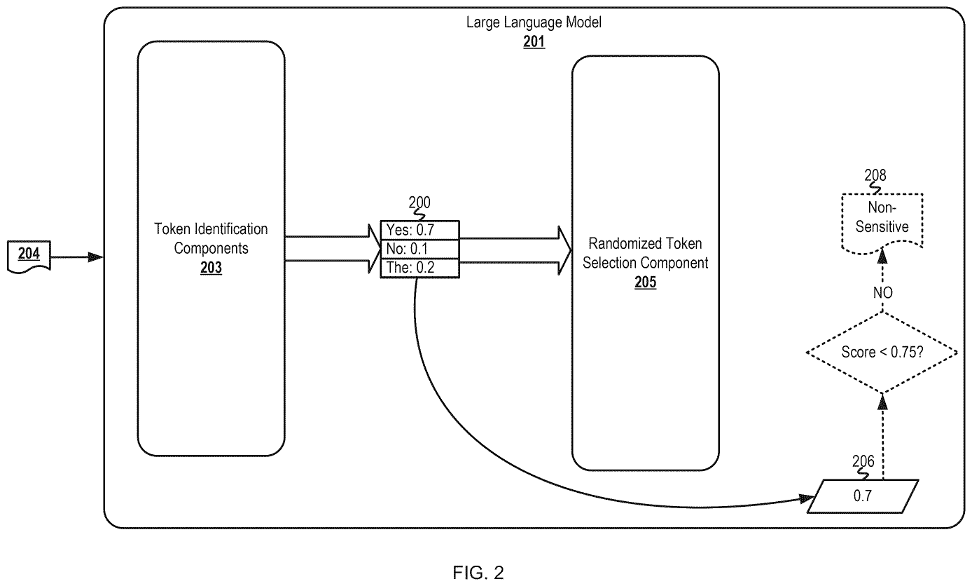

FIG. 1 is a diagram of a category-agnostic DLP system computing category-agnostic metrics of clusters with LLMs. The category-agnostic DLP system, although not explicitly depicted, includes all of the components for generating metrics and evaluating clusters for containing shadow data such as prompt generators, LLMs, embedding models, databases, classifiers, etc. FIG. 1 is annotated with a series of letters A and B representing stages of operations, each stage corresponding to one or more operations. FIG. 2 is annotated with a series of letters A-C also representing stages of operations. Although these stages are ordered for this example, the stages illustrate one example to aid in understanding this disclosure and should not be used to limit the claims. Subject matter falling within the scope of the claims can vary from what is illustrated.

At stage A, a prompt generator 101 receives a cluster description 104 and document summaries 106 for documents in a document embedding cluster 102A among document embedding clusters (hereinafter “clusters”) 102A-102C. A first metric for the clusters 102A-102C is numbers of documents 100A-100C, comprising 8 documents, 7 documents, and 6 documents, respectively. Although the numbers of documents 100A-100C are indicated as cluster parameters in FIG. 1, they will be subsequently used as metrics for shadow data categorization of clusters. The computation of other metrics used for shadow data categorization is more involved and is described in the remainder.

The clusters 102A-102C were generated according to embeddings (e.g., natural language processing (NLP) embeddings or embeddings generated by LLMs) of corresponding document summaries, for instance by using Uniform Manifold Approximation and Projection for Dimension Reduction (UMAP) or another dimension reduction technique on the embeddings and then Hierarchical Density-Based Spatial Clustering of Applications with Noise (HDBSCAN) or another clustering algorithm. The document summaries can be obtained from original customer documents by prompting an LLM or invoking an extractive summarization model, an abstractive summarization model, etc. As documents are obtained and clustered, the clusters 102A-102C can be updated accordingly. In some instances, as clusters for existing/known categories of sensitive data evolve, any of the clusters 102A-102C can be subsumed by the existing/known clusters and subsequently removed from consideration as corresponding to shadow data.

The prompt generator 101 populates a prompt template 114 with the cluster description 104 and populates separate instances of a prompt template 116 with each of the document summaries 106 to obtain a prompt 108 and prompts 110, respectively, intended for an LLM 103A and an LLM 103B, respectively. The prompt template 114 comprises the following text (wherein the cluster description 104 is inserted into the “{Description}” placeholder):
Based on the following cluster description, do you think this cluster contains any internal sensitive data that the company would not want to leak?
Cluster Description: {Description}
Answer: {Yes/No}

The prompt template 116 comprises the following text (wherein each document summary for each instance of the prompt template 116 is inserted into the “{Summary}” placeholder):
Based on the document summary below, do you think this document contains any internal sensitive data that the company would not want to leak?
Document Summary: {Summary}
Answer: {Yes/No}

At stage B, the LLMs 103A, 103B determine sensitivity metrics for the cluster 102A and documents in the cluster 102A based on a probability value of the “Yes” token being the subsequent output of each of the LLMs 103A, 103B from being prompted with the prompts 108, 110, respectively. Each of the LLMs 103A, 103B is an open-source LLM that is configured to (i.e., modified based on an open-source LLM or chosen as a setting of an LLM depending on the LLM chosen), instead of randomly selecting the next token with highest probability among a vector of token probabilities (and then proceeding to the subsequent tokens until a “stop” token is selected) when responding to a prompt, output the vector of probabilities and corresponding tokens. A sensitivity metric 112A for the cluster 102A using outputs of the LLM 103A is determined by taking the probability of the “Yes” token being chosen as the next token in the probability vector. A sensitivity metric 112B for documents in the cluster 102A using outputs of the LLM 103B is determined by, for each document, taking the probability of the “Yes” token being the next token, comparing the probability against a threshold (e.g., 0.75), labelling the document as “sensitive” if the probability is above the threshold and “non-sensitive” otherwise, then computing the sensitivity metric 112B as the percentage of documents labeled as sensitive. The operations for extracting the probability of the next token being a “Yes” token and (optionally) comparing the probability against a threshold are illustrated in FIG. 2.

FIG. 2 is an illustrative diagram of determining a sensitivity label and/or metric for a document and/or cluster using next token probabilities for an LLM. The description of FIG. 2 makes reference to various components in FIG. 1 as examples that are illustrated in further detail in FIG. 2. An LLM 201 (e.g., one of the LLMs 103A, 103B) comprises token identification components 203 that output probability vectors of next tokens and a randomized token selection component 205 that randomly selects one of the next tokens according to each of the probability vectors to output. The LLM 201 has been configured so that the randomized token selection component 205 does not receive next token probability vectors, and instead the next token probability vectors (or postprocessing thereof) are used as outputs.

The LLM 201 receives an input 204 (e.g., the cluster description 104 or one of the document summaries 106) and outputs a token probability vector 200 indicating the following token/probability value pairs (the “Yes” token appears first in this example for simplicity, although this may not occur in practice):
Yes: 0.7
No: 0.1
The: 0.2

The LLM 201 is configured to identify and output a probability value 206 for “Yes” being the next token (0.7 in the example). For the case of a cluster description, this is the sensitivity metric of the cluster. For the case of a summary embedding (with operations depicted in with dashed lines), the LLM 201 determines whether the probability value 206 is below a threshold value (0.75 in the depicted example), and assigns a “non-sensitive” label if the probability value is below the threshold and a “sensitive” label otherwise. In the depicted example, the probability value 206 of 0.7 is below the threshold 0.75, and therefore the input 204 is assigned a non-sensitive label 208.

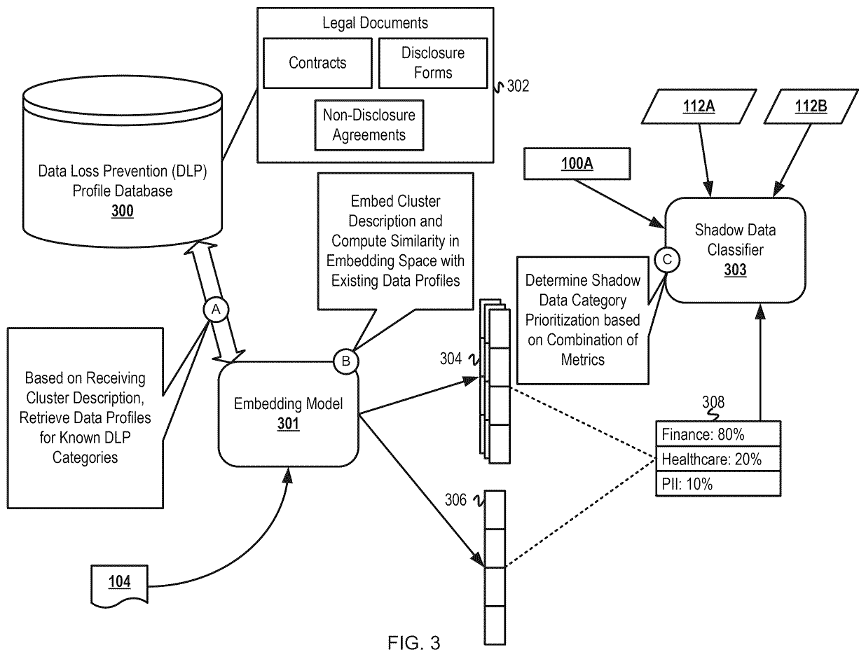

FIG. 3 is a diagram of the category-agnostic DLP system computing a cluster similarity metric of an unknown cluster with clusters having known sensitive data categories, and determining whether the unknown cluster corresponds to shadow data based on a combination of metrics. FIG. 3 depicts many of the components/data in FIG. 1 for the purposes of computing additional metrics thereof and determining whether the cluster 102A in FIG. 1 corresponds to shadow data.

FIG. 3 is annotated with a series of letters A-C representing stages of operations. Although these stages are ordered for this example, the stages illustrate one example to aid in understanding this disclosure and should not be used to limit the claims. Subject matter falling within the scope of the claims can vary from what is illustrated.

At stage A, an embedding model 301 receives the cluster description 104 and retrieves data profiles for known DLP categories from a DLP profile database 300. Each data profile is a description of a corresponding sensitive data category similar to the cluster descriptions described in the foregoing. The known DLP categories can have a hierarchical structure as illustrated by example categories 302, wherein a “legal documents” category includes “contracts”, “disclosure forms”, and “non-disclosure agreements” as sub-categories. Depending on granularity of the similarity metric to be computed, the embedding model 301 can retrieve all data profiles or data profiles from a particular level of the hierarchy. Although the foregoing description refers to the embedding model 301 as retrieving data profiles, the embedding model 301 retrieves embeddings 304 of the data profiles for subsequently determining similarity with the cluster description 104.

At stage B, the embedding model 301 generates an embedding 306 (e.g., an NLP embedding or embedding from prompting an LLM) of the cluster description 104. The embedding model 301 then computes pairwise similarity (e.g., cosine similarity) of the embedding 306 with each of the embeddings 304 of the retrieved data profiles. Output 308 of the embedding model 301 from the similarity computation is a list of sensitive data categories and the percentage similarity of each of the sensitive data categories with the cluster 102A according to the similarity metric. In this example, the output 308 indicates a similarity of 80% with the finance category, a similarity of 20% with the healthcare category, and a similarity of 10% with the personally identifiable information (PII) category. In some instances, the output 308 can be truncated at a fixed number of known sensitive data categories, only the highest similarity known sensitive data category, at a threshold similarity metric, etc.

At stage C, a shadow data classifier 303 determines shadow data category prioritization for the cluster 102A and other unknown clusters based on a combination of the number of documents 100A, the sensitivity metrics 112A, 112B, and the output 308. For instance, the shadow data classifier 303 can compute, for each unknown cluster including the cluster 102A, a weighted average of the metrics 100A, 112A, 112B, and output 308 and rank the clusters for prioritization based on the weighted averages, with highest weighted averages having highest prioritization. Alternatively, the shadow data classifier 303 can perform a multiple-key sort using each of the metrics as keys (i.e., by sorting clusters by a first metric, further sorting the keys by a second metric, etc.) and take the highest clusters in the sorting as highest priority for corresponding to a shadow data category. For the weighted average, higher weights can be assigned to metrics perceived to have higher importance for detecting clusters of shadow data, and the multi-key sorting can start with those higher importance metrics. As an example, an ordering of the metrics from most to least important can be 112B, 100A, 112A, and 308.

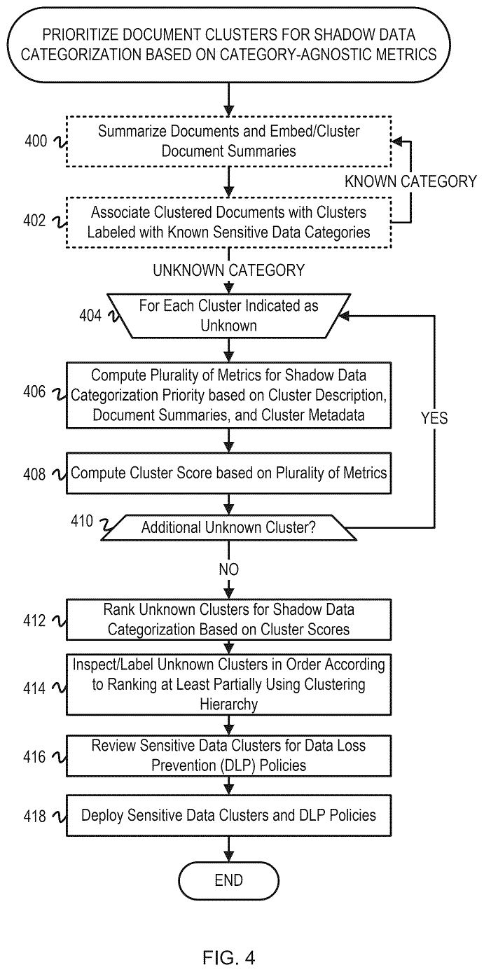

FIGS. 4-7 are flowcharts of example operations for prioritizing unknown clusters of documents for potential categorization as shadow data using various category-agnostic and category-dependent metrics. The example operations are described with reference to a category-agnostic DLP system (“DLP system”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for prioritizing document clusters for shadow data categorization based on category-agnostic metrics. The first two blocks 400, 402 of FIG. 4 are depicted with dashed outlines to indicate that the operations at these blocks occur as part of a separate DLP pipeline for ingesting new (potentially sensitive) documents as they are detected by an organization, generating embeddings of the documents, clustering the embeddings, and periodically updating clusters/identifying unknown clusters not having labels corresponding to known sensitive data categories. The remaining operations in FIG. 4 are triggered when an unknown cluster is identified as part of this pipeline. If categories of clustered documents remain known, then the operations continue at blocks 400, 402.

At block 400, the DLP system summarizes documents and embeds/clusters the document summaries. For instance, the DLP system can prompt an LLM and/or extractive or abstractive summarization model to summarize each document. The DLP system can detect documents across an organization (e.g., as they are stored on endpoint devices of the organization, communicated across local networks or external gateways of the organization, etc.). The DLP system can use various DLP techniques such as regular expressions, optical character recognition, etc. to flag documents as comprising potentially sensitive data and then forward them for summarization/embedding/clustering. In some embodiments, all documents communicated across or external to an organization can be summarized/embedded/clustered, so as to attempt to detect and categorize documents from unknown shadow data categories not yet catalogued by the organization.

At block 402, the DLP system associates clustered documents with existing clusters labeled with known data categories. For example, a document embedding or sub-cluster of document embeddings may be subsumed by an existing cluster for a known sensitive label category when that embedding or sub-cluster is within a distance threshold for subsumption (e.g., within one standard deviation distance from the cluster center with the standard deviation computed among all distances from existing document summary embeddings to the cluster center of the cluster). If an embedding or cluster of document embeddings is not subsumed by an existing known sensitive cluster, operational flow proceeds to block 404. In some instances, the DLP system may wait until a threshold number of unknown clusters are detected before proceeding to block 404. Otherwise, operational flow returns to block 400.

At block 404, the DLP system begins iterating through clusters currently indicated as unknown that have not yet been assigned cluster metrics that determine priority for shadow data categorization. Each unknown cluster is assumed to have a corresponding cluster description, document summaries, embeddings thereof, and cluster metadata already maintained in memory.

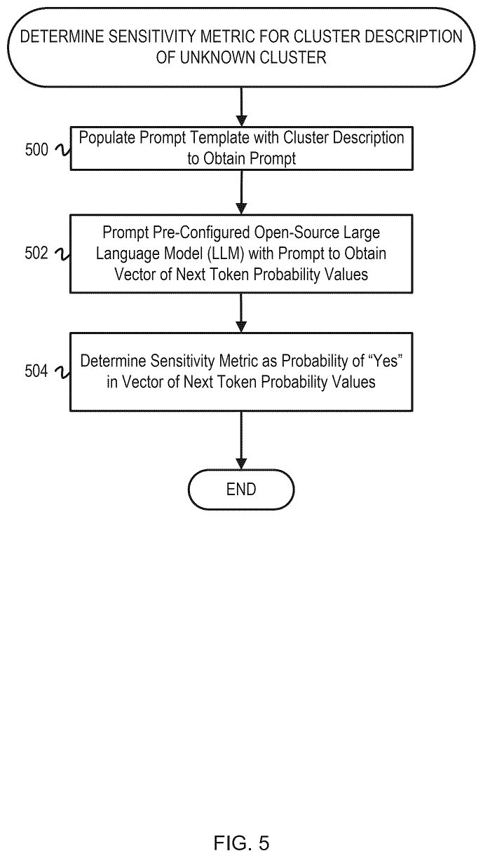

At block 406, the DLP system computes a plurality of metrics for shadow data categorization priority based on the cluster description, the document summaries, and the cluster metadata. The metrics comprise both categorization-agnostic and categorization-dependent metrics (referring to whether the metrics depend on existing categories of sensitive data for the organization) that will be described in the subsequent flowcharts (i.e., the flowcharts of FIGS. 5-7).

At block 408, the DLP system computes a cluster metric (i.e., an aggregate or overall metric) for the unknown cluster based on the plurality of metrics. This computation depends on choice, scaling, and priority of the plurality of metrics. For instance, the cluster metric can be computed as a weighted average of the plurality of metrics with weights favoring higher priority metrics that are more meaningful for shadow data categorization. Alternatively, the cluster metric can be a tuple of the plurality of metrics that will be subsequently used for multiple-key sorting when clusters are subsequently ranked according to the metrics.

At block 410, the DLP system continues iterating through unknown clusters. If there is an additional unknown cluster, operational flow returns to block 404. Otherwise, operational flow proceeds to block 412.

At block 412, the DLP system ranks unknown clusters for shadow data categorization based on the computed metrics. If the cluster metrics are individual values, then the ranking is simply a list of clusters from lowest to highest metric (with highest metric corresponding to highest priority). If the cluster metrics are tuples of metrics or metrics, then the ranking can comprise a multiple-key sorting of the tuples according to known highest and lowest priority of metrics within the tuples (with ranking starting with the highest priority entries of the tuples).

At block 414, the DLP system inspects/labels the unknown clusters in order according to the ranking. For instance, a domain-level expert can manually inspect the document descriptions and cluster descriptions of the unknown clusters to attempt to label the clusters with categories. As unknown clusters are assigned known categories, DLP techniques applied across the organization such as regular expressions, trained sensitive data detection models, etc. can be updated to better detect these additional known categories. Newly labeled clusters can be placed within a hierarchy of clusters for the organization according to the embeddings within the labeled clusters. Referring to the previous example in FIG. 3, a newly labeled cluster can comprise disclosure forms. Based on proximity of cluster embeddings, this cluster can be determined to be with the legal documents cluster, but distinct from non-disclosure agreements and contracts. This placement can be determined by using cluster statistics such as a centroid embedding and a mean of embedding distances to the centroid. To exemplify, a newly labeled cluster can be placed within a larger existing cluster if the centroid of the newly labeled cluster is with a threshold number of the mean embedding distances of the centroid of the larger existing cluster, but can be separated from other clusters at lower levels of the hierarchy if the respective centroids are above a different threshold number of the mean embedding distances.

At block 416, the DLP system (and/or a customer) reviews sensitive data clusters (identified as known at block 414 above) for DLP policies. The DLP policies comprise measures to take when documents from a category corresponding to each sensitive data cluster are detected within an organization, and can include blocking, sanitizing, or performing other remediation actions on documents detected for each sensitive data category.

At block 418, the DLP system deploys the sensitive data clusters and DLP policies. For instance, detection of documents within each category can comprise determining that embeddings of document summaries are close to a corresponding cluster, or can use regular expressions, trained detection models on the cluster documents, etc. Detected documents are remediated according to the DLP policies.

FIG. 5 is a flowchart of example operations for determining a sensitivity metric for a cluster description of an unknown cluster. At block 500, the DLP system populates a prompt template with a cluster description of the unknown cluster to obtain a prompt. For instance, the prompt template can comprise task instructions to evaluate whether the cluster description contains internal/sensitive data that the organization would not want to leak, and an indication to provide the answer to the prompt as a “Yes” or “No” token.

At block 502, the DLP system prompts a pre-configured open-source LLM with the prompt to obtain a vector of next token probability values. The open-source LLM is pre-configured/modified to, instead of sequentially outputting each next token in response to a prompt, output a vector of probability values for initial next tokens in response to the prompt. For instance, the open-source LLM can be modified by removing a sub-component that randomly selects the next token based on the vector of probability values.

At block 504, the DLP system determines a sensitivity metric for the unknown cluster as a probability value corresponding to “Yes” in the vector of probability values. The sensitivity metric is 0 if “Yes” is not present in the vector of next tokens.

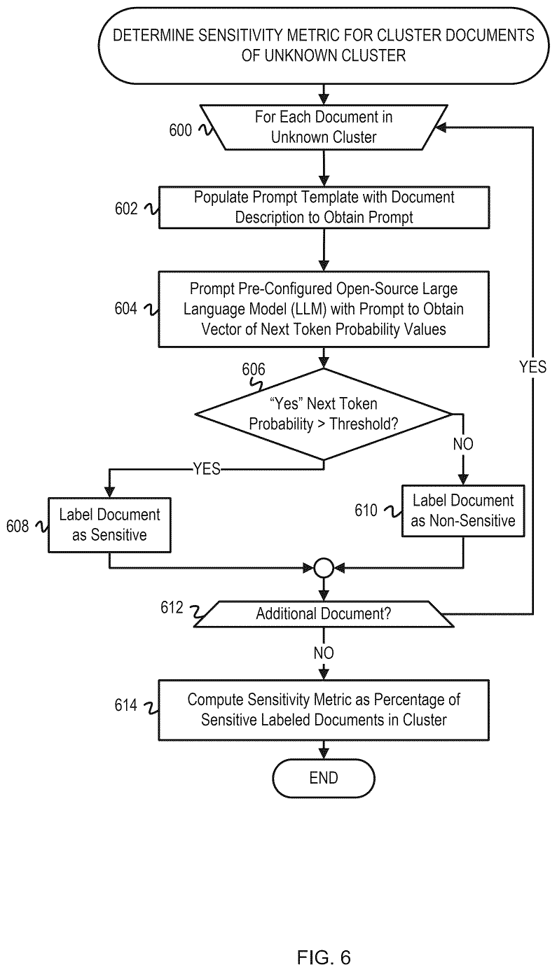

FIG. 6 is a flowchart of example operations for determining a sensitivity metric for cluster documents of an unknown cluster. Many of the example operations in FIG. 6 are described in brevity due to overlap with operations in FIG. 5. At block 600, the DLP system begins iterating through documents in the unknown cluster.

At block 602, the DLP system populates a prompt template with a description of the current document to obtain a prompt. The prompt template can comprise task instructions to determine whether the document contains internal/sensitive data that the organization would not want to leak and to output a “Yes” or “No” token.

At block 604, the DLP system prompts a pre-configured open-source LLM with a prompt to obtain a vector of next token probability values. The open-source LLM can be pre-configured/modified similarly to the LLM described at block 502 in reference to FIG. 5.

At block 606, the DLP system determines whether the probability value of “Yes” being the next token according to the vector of probability values is above a threshold. If the probability value is above the threshold, operational flow proceeds at block 608 and the document is labeled as sensitive. If the probability is less than or equal to the threshold, operational flow proceeds at block 610 and the document is labeled as non-sensitive. Operational flow proceeds at block 612 from both blocks 608 and 610.

At block 612, the DLP system determines whether there is an additional document in the unknown cluster. If there is an additional document, operational flow returns to block 600. Otherwise, operational flow proceeds to block 614.

At block 614, the DLP system computes the sensitivity metric as a percentage of documents in the cluster that were labeled as sensitive. In some embodiments, depending on the scaling of other metrics used for ranking/prioritizing clusters, the percentage can be scaled accordingly.

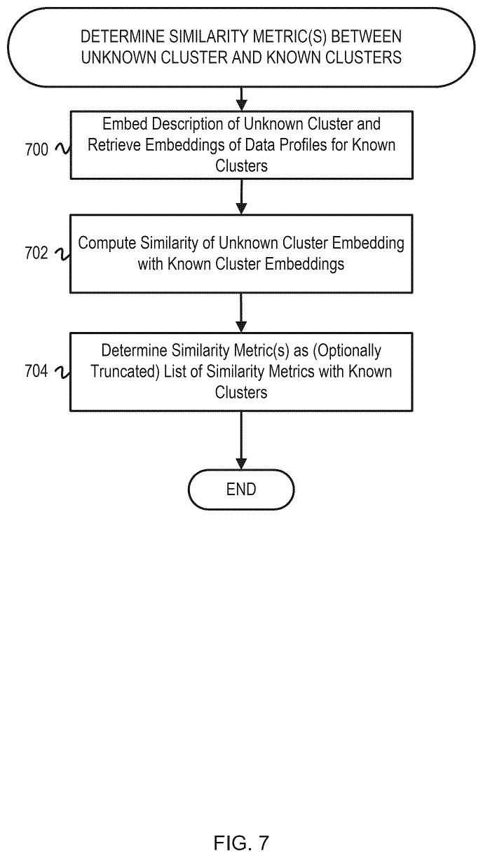

FIG. 7 is a flowchart of example operations for determining a similarity metric(s) between an unknown cluster and known clusters. At block 700, the DLP system embeds a description of the unknown cluster and retrieves embeddings of data profiles for the known clusters. For instance, the embeddings can be NLP embeddings (e.g., word2vec, doc2vec), embeddings obtained from prompting an LLM, etc. Each of the data profiles is a well-catalogued description of a sensitive data category known to an organization that has been tracked/updated periodically as additional data related to that category has been collected over time.

At block 702, the DLP system computes a similarity of the unknown cluster embedding with the known cluster embeddings (i.e., the embeddings of the data profiles of clusters). For instance, the DLP system can compute each pairwise similarity as a cosine similarity.

At block 704, the DLP system determines a similarity metric(s) as an (optionally truncated) list of similarity metrics with the known clusters. Computation of the similarity metric(s) can vary by implementation—the list of similarity metrics can be truncated based on a threshold number of similarities, a threshold similarity value, etc. and/or a maximal similarity metric can be kept, an average similarity value can be kept, etc.

### Variations

Any of the category-agnostic and category-dependent metrics are interchangeable based on implementations and can be modified, removed, scaled, etc. as appropriate. Any of the LLMs can be fine-tuned, prompt-tuned, etc. for their respective tasks and a same LLM can be used for multiple of the foregoing tasks described in the foregoing. As an example, an LLM in the Qwen® family of LLMs can be used for any of the summarization or sensitivity detection tasks. Any of the foregoing “metrics” can alternatively be referred to as “scores.”

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks at 404, 406, 408, and 410 can be performed in parallel or concurrently as unknown clusters are identified. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

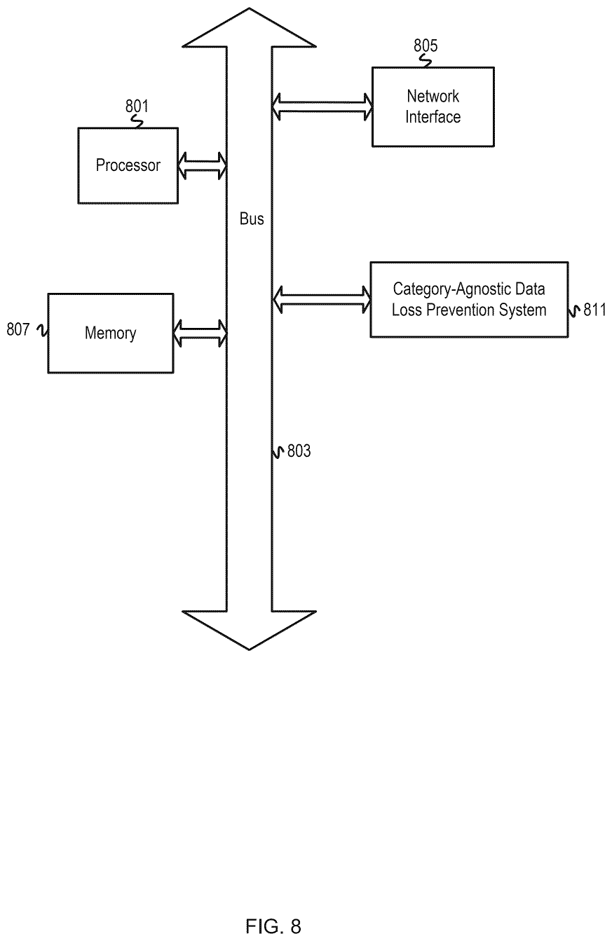

FIG. 8 depicts an example computer system with a category-agnostic DLP system. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a category-agnostic DLP system (“DLP system”) 811. The DLP system 811 periodically identifies documents across an organization as possibly comprising sensitive data and/or being vulnerable to data leakage. The DLP system 811 embeds and clusters the documents, then identifies “unknown” clusters that do not correspond to any known sensitive data categories for the organization. For each identified unknown cluster, the DLP system 811 computes a plurality of both category-agnostic and category-dependent metrics. The DLP system 811 then populates a priority list for the unknown clusters by computing aggregate cluster metrics according to the computed metrics. Unknown clusters with the highest cluster metrics are evaluated first as possibly corresponding to sensitive data categories not previously known to the organization. As these new sensitive data categories are identified, the DLP system 811 is updated with regular expressions, models, etc. configured to handle the additional categories. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
obtaining a cluster corresponding to a plurality of documents for an organization, wherein the cluster comprises embeddings of summaries of a plurality of documents, wherein the cluster corresponds to a description of the plurality of documents in the cluster;
generating a plurality of metrics that at least partially measure sensitivity of the cluster, wherein at least a subset of the plurality of metrics comprises metrics that are agnostic to existing sensitive data categories for the organization; and
determining that the cluster is high priority of corresponding to a shadow data category for data loss prevention for the organization based, at least in part, on the plurality of metrics.

2. The method of claim 1, further comprising generating a first metric of the plurality of metrics, wherein generating the first metric comprises:
for each document of the plurality of documents, invoking a first language model with a first prompt comprising task instructions to output an indicator for whether a summary of the document comprises sensitive data; and
generating the first metric as a percentage of the plurality of documents that the first language model indicated as comprising sensitive data.

3. The method of claim 1, wherein a second metric of the plurality of metrics comprises a number of the plurality of documents.

4. The method of claim 1, further comprising generating a third metric of the plurality of metrics, wherein generating the third metric comprises:
configuring a second language model to access a vector of probabilities for a next token output by the second language model;
invoking the second language model on a second prompt comprising task instructions to output an indicator of whether the description of the plurality of documents corresponds to sensitive data;
accessing the vector of probabilities for the next token output by the second language model from invoking the second language model on the second prompt; and
generating the third metric as a probability in the vector of probabilities of the next token being a yes token.

5. The method of claim 1, wherein generating a fourth metric of the plurality of metrics comprises generating the fourth metric as a similarity metric between the description of the plurality of documents and known sensitive data category profiles.

6. The method of claim 1, wherein determining that the cluster is high priority of corresponding to a shadow data category comprises:
computing an aggregate metric for the cluster as a weighted average of the plurality of metrics; and
determining that the aggregate metric exceeds is high relative to aggregate metrics of other clusters.

7. The method of claim 1, wherein determining that the cluster is high priority of corresponding to a shadow data category comprises:
computing the plurality of metrics for the cluster and additional metrics for an additional one or more clusters also corresponding to the organization;
performing multiple-key sorting on the plurality of metrics and the additional metrics to generate a ranking of the cluster and the additional one or more clusters; and
determining that the cluster has a high rank according to the ranking.

8. The method of claim 1, further comprising determining a placement of the category corresponding to shadow data in a hierarchy of known sensitive data categories for the organization.

9. A non-transitory machine-readable medium having program code stored thereon, the program code comprising instructions to:
obtain a cluster corresponding to a plurality of documents for an organization, wherein the cluster comprises embeddings of summaries of a plurality of documents, wherein the cluster corresponds to a description of the plurality of documents in the cluster;
generating a plurality of metrics related to whether the cluster comprises shadow data, wherein at least a subset of the plurality of metrics comprises metrics that are agnostic to existing sensitive data categories for the organization; and
determine that the cluster is high priority of corresponding to a shadow data category for data loss prevention for the organization based, at least in part, on the plurality of metrics.

10. The non-transitory machine-readable media of claim 9, wherein the program code further comprises instructions to generate a first metric of the plurality of metrics, wherein the instructions to generate the first metric comprise instructions to:
for each document of the plurality of documents, invoke a first language model with a first prompt comprising task instructions to output an indicator for whether a summary of the document comprises sensitive data; and
generate the first metric as a percentage of the plurality of documents that the first language model indicated as comprising sensitive data with a probability value over a threshold probability value.

11. The non-transitory machine-readable media of claim 9, wherein a second metric of the plurality of metrics comprises a number of the plurality of documents.

12. The non-transitory machine-readable media of claim 9, wherein the program code further comprises instructions to generate a third metric of the plurality of metrics, wherein the instructions to generate the third metric comprise instructions to:
configure a second language model to access a vector of probabilities for a next token output by the second language model;
invoke the second language model on a second prompt comprising task instructions to output an indicator of whether the description of the plurality of documents corresponds to sensitive data;
access the vector of probabilities for the next token output by the second language model from invoking the second language model on the second prompt; and
generate the third metric as a probability in the vector of probabilities of the next token being a yes token.

13. The non-transitory machine-readable media of claim 9, wherein the program code further comprises instructions to generate a fourth metric of the plurality of metrics, wherein the instructions to generate the fourth metric comprise instructions to generate the fourth metric as a similarity metric between the description of the plurality of documents and known sensitive data category profiles.

14. The non-transitory machine-readable media of claim 9, wherein the instructions to determine that the cluster is high priority of corresponding to a shadow data category comprise instructions to:
compute an aggregate metric for the cluster as a weighted average of the plurality of metrics; and
determine that the aggregate metric exceeds is high relative to aggregate metrics of other clusters.

15. The non-transitory machine-readable media of claim 9, wherein the instructions to determine that the cluster is high priority of corresponding to a shadow data category comprise instructions to:
compute the plurality of metrics for the cluster and additional metrics for an additional one or more clusters also corresponding to the organization;
perform multiple-key sorting on the plurality of metrics and the additional metrics to generate a ranking of the cluster and the additional one or more clusters; and
determine that the cluster has a high rank according to the ranking.

16. An apparatus comprising:
a processor; and
a machine-readable medium having instructions stored thereon that are executable by the processor to cause the apparatus to,
based on obtaining clusters of documents not known to correspond to one or more categories of sensitive data for an organization,
for each cluster of the clusters,
generate a plurality of metrics that at least partially measure sensitivity for the cluster based, at least in part, on summaries of a plurality of documents in the cluster and a description of the cluster, wherein at least a subset of the plurality of metrics comprises metrics that are agnostic to known sensitive data categories for the organization; and
computing an aggregate metric for the cluster based on the plurality of metrics; and
ranking the clusters for prioritization of shadow data category evaluation according to the computed aggregate metrics.

17. The apparatus of claim 16, wherein the machine-readable medium further has stored thereon instructions executable by the processor to cause the apparatus to generate a first metric of the plurality of metrics, wherein the instructions to generate the first metric comprise instructions executable by the processor to cause the apparatus to:
for each document of the plurality of documents, invoke a first language model with a first prompt comprising task instructions to output an indicator for whether a summary of the document comprises sensitive data; and
generate the first metric as a percentage of the plurality of documents that the first language model indicated as comprising sensitive data with a probability value over a threshold probability value.

18. The apparatus of claim 16, wherein a second metric of the plurality of metrics comprises a number of the plurality of documents.

19. The apparatus of claim 16, wherein the machine-readable medium further has stored thereon instructions executable by the processor to cause the apparatus to generate a third metric of the plurality of metrics, wherein the instructions to generate the third metric comprise instructions executable by the processor to cause the apparatus to:
configure a second language model to access a vector of probabilities for a next token output by the second language model;
invoke the second language model on a second prompt comprising task instructions to output an indicator of whether the description of the cluster corresponds to sensitive data;
access the vector of probabilities for the next token output by the second language model from invoking the second language model on the second prompt; and
generate the third metric as a probability in the vector of probabilities of the next token being a yes token.

20. The apparatus of claim 16, wherein the machine-readable medium further has stored thereon instructions executable by the processor to cause the apparatus to generate a fourth metric of the plurality of metrics, wherein the instructions to generate the fourth metric comprise instructions executable by the processor to cause the apparatus to generate the fourth metric as a similarity metric between the description of cluster and known sensitive data category profiles.
